(19) United States
(12) Patent Application Publication
(10) Pub. No.: US 2011/0307302 A1
(43) Pub. Date: Dec. 15, 2011

(54) SYSTEMS AND METHODS FOR ENHANCING COMMUNICATION BETWEEN PARTNERS IN SPONSORSHIPS

(76) Inventor: Len Perna, Haddonfield, NJ (US)

(21) Appl. No.: 13/157,956

(22) Filed: Jun. 10, 2011

Related U.S. Application Data
(60) Provisional application No. 61/353,676, filed on Jun. 11, 2010.

(51) Int. Cl. G06Q 10/00

(52) U.S. Cl. 705/7.39

(57) ABSTRACT

The present disclosure is directed to, among other things, a method. The method can include receiving, by a processor executing on a server, a request to create a channel associated with a first sponsorship. The method can include creating, by the processor, the channel with a shared workspace accessible to a first party to the sponsorship and a second party to the sponsorship, wherein the first party and the second party track terms of the sponsorship via the shared workspace. The method can include granting, by the processor, a first set of access privileges for the channel to the first party.

### RELATED APPLICATION

The present application claims priority to U.S. Provisional Application No. 61/353,676, “Systems and Methods for Enhancing Communication, Collaboration, Measurement and Content Sharing in Sponsorships Between Marketing Partners,” filed Jun. 11, 2010, the contents of which are hereby incorporated by reference in their entirety.

### BACKGROUND

In any sponsorship, there is the seller of the sponsorship (the “Property”) and the buyer of the sponsorship (the “Sponsor”). The two parties work together during the term of their sponsorship agreement as marketing partners. Properties can be in the media (e.g., TV, radio, print, digital, etc.), sports, entertainment, live events, experiential marketing, cause marketing, performing arts, museums, convention centers, fairs & festivals, amusement parks, or any other business with a coveted audience and co-branding opportunities. Sponsors can be companies and/or brands looking to market to a Property's audience by aligning themselves with the Property.

Marketing partners typically meet to formalize an agreement, negotiating the terms and deliverables the Property shall fulfill in exchange for the Sponsor's support and funding. For example, a Property can agree to provide a Sponsor a variety of benefits, such as advertising, media, hospitality, tickets, co-branding, merchandise, and/or licensing. However, today in the sponsorship industry, after the parties sign the sponsorship agreement and transition into fulfillment, the parties communicate sporadically using generic, desktop-constrained work flow systems like email, word processing, spreadsheets, and presentation software that is not geared toward the unique needs of marketing partners. Working in this manner in today's sponsorship world, the parties often struggle to fully activate and optimize the sponsorship.

### SUMMARY

In some aspects, the present disclosure is directed to a method. The method can include receiving, by a processor executing on a server, a request to create a channel associated with a first sponsorship. The method can include creating, by the processor, the channel with a shared workspace accessible to a first party to the sponsorship and a second party to the sponsorship, wherein the first party and the second party track terms of the sponsorship via the shared workspace. The method can include granting, by the processor, a first set of access privileges for the channel to the first party.

The method can include granting, by the processor, a second set of access privileges for the channel to the second party in response to identification of the second party by the first party. Creating the channel can include creating the channel with the shared workspace to track at least one of contracts, periods, programs, deliverables, and occurrences associated with the sponsorship. The method can include receiving, by the processor, a message regarding a status of a deliverable; and modifying, by the processor, the shared workspace according to the status of the deliverable. The method can include displaying, by the processor, metrics of the sponsorship in the shared workspace to the first party. The method can include displaying, by the processor, the channel associated with the first sponsorship and a channel associated with a second sponsorship to a member of the first party. The method can include granting, by the processor, a first subset of the first set of access privileges to a first member of the first party; and granting, by the processor, a second subset of the first set of access privileges to a second member of the first party. Creating the channel can include creating, by the processor, a first private workspace accessible to the first party; and creating, by the processor, a second private workspace accessible to the second party. The method can include generating, by the processor, a report on the sponsorship according to data in the shared workplace.

In some aspects, the present disclosure is directed to a system. The system can include a processor and a memory. The memory can store instructions that, when executed by the processor, cause the processor to: receive a request to create a channel associated with a first sponsorship; create the channel with a shared workspace accessible to a first party to the sponsorship and a second party to the sponsorship, wherein the first party and the second party track terms of the sponsorship via the shared workspace; and grant a first set of access privileges for the channel to the first party.

### BRIEF DESCRIPTION OF THE DRAWING

The foregoing and other objects, aspects, features, and advantages of the present disclosure will become more apparent and better understood by referring to the following description taken in conjunction with the accompanying drawings, in which:

FIG. 1 depicts an implementation of the Channels in a Patron's sponsorship portfolio, wherein the Patron is a Property;

FIG. 2 depicts an implementation of the Channels in a Patron's sponsorship portfolio, wherein the Patron is a Sponsor;

FIGS. 3A and 3B depict exemplary screenshots of homepages with Channels;

FIG. 4 depicts an exemplary screenshot summarizing information for a Channel;

FIGS. 5-7 depict exemplary screenshots for managing and adding users to Channels;

FIG. 8 depicts an exemplary screenshot of assigning Channel permissions to users;

FIG. 9 depicts an exemplary screenshot of customizing permissions for a role for a user;

FIG. 10 depicts an exemplary screenshot tracking obligations of a sponsorship agreement;

FIG. 11 depicts an exemplary screenshot of a calendar for a Channel;

FIG. 12 depicts an exemplary screenshot of an archive (e.g., archive vault, secure file transfer) of a Channel;

FIG. 13 depicts an exemplary screenshot of a gallery of a Channel;

FIG. 14 depicts an exemplary screenshot of a bulletin board of a Channel;

FIG. 15 depicts an exemplary screenshot of a feedback mechanism for a Channel;

FIG. 16 depicts an exemplary screenshot displaying data services available for a Channel;

FIG. 17 depicts an exemplary screenshot of a homepage with Channels;

FIG. 18 depicts an exemplary screenshot summarizing information for a Channel;

FIG. 19 depicts another exemplary screenshot of a bulletin board of a Channel;

FIGS. 20-22 depict exemplary screenshots tracking obligations of a sponsorship agreement;

FIG. 23-24 depict exemplary screenshots of feedback mechanisms for a Channel;

FIG. 25 depicts exemplary icons for applications associated with a Channel;

FIG. 26 depicts an exemplary screenshot of a library of a Channel;

FIGS. 27-28 depict exemplary screenshots for managing users of a Channel;

FIG. 29 is a block diagram of an exemplary system for enhancing communication between partners in sponsorships; and

FIG. 30 is an exemplary computing device for a client or server used with the system of FIG. 29.

### DETAILED DESCRIPTION OF CERTAIN EMBODIMENTS

In some aspects, the present disclosure is directed to a platform for an online, hosted software solution. The platform provides sponsorship marketing partners with a two-way Channel of communication to, for example, share, plan, organize, track, analyze, and/or summarize information related to the parties' sponsorship relationship. The information can be dynamically updated. The marketing partners can access all the information pertaining to the sponsorship remotely, regardless of their location and the time of day. The Channel can serve as a repository of events in the sponsorship, e.g., a central archive for documenting the ongoing history of the relationship and progress on deliverables.

The platform can coordinate the parties' abilities in maintaining and optimizing the sponsorship. Such transparency can promote a greater sense of accountability for Properties and their Sponsors. Both parties can be in tune and on the “same page” with the daily progress of their marketing partnership, from setting goals and mutual expectations to the full realization of the deliverables and potential new opportunities of the sponsorship.

In some aspects, the present application is generally directed to systems and methods for enhancing communication between parties to a sponsorship (also referred to herein as “marketing partners”). A hosted platform can create a separate, dedicated Channel for a sponsorship between two marketing partners. One side of the sponsorship purchases a Channel (the “Patron”) and provides access to the other side of the Channel to their marketing partner (the “Recipient”). A party that has purchased multiple Channels can access all of their Channels on the platform. In this manner, parties can manage their sponsorships from a single account.

The platform of the present disclosure permits parties in sponsorship agreements to remotely access, plan, manage, measure and evaluate their relationships in real-time using a system that is designed and built specifically for sponsorships. From a single platform account, Properties can manage and organize their sponsorship client roster. Likewise, Sponsors and/or their marketing agencies can access, plan, manage, measure and evaluate their entire sponsorship portfolio from a single account.

The platform can achieve this objective by providing a dedicated Channel between a Property and each of its Sponsors, and/or vice versa. In some implementations, a Channel can be a network location providing a two-way online information sharing environment for use by authorized users associated with the two parties to a sponsorship, for the benefit of their sponsorship agreement. Access on each side of the sponsorship can be password protected and strictly limited only to the authorized users of each of the marketing partners.

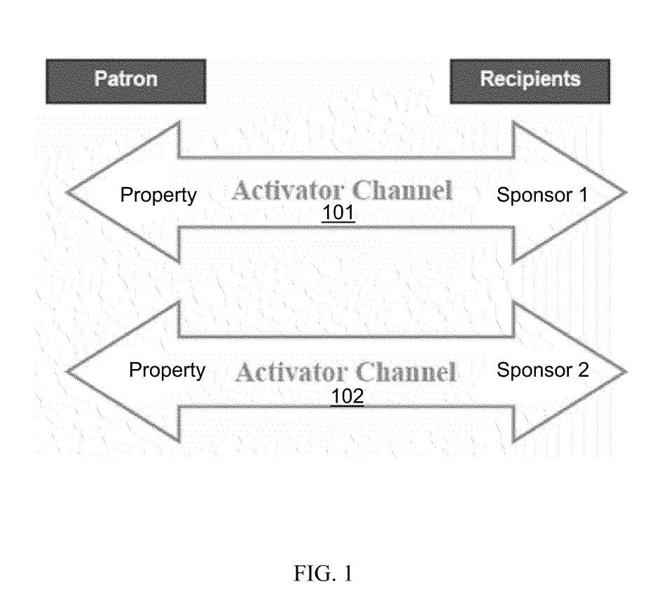

In one example, depicted in FIG. 1, a property signs a Patron agreement with the platform provider. Thus, the Property becomes the platform provider's client and the Patron of the created Channel 101. The Property can sign a second Patron agreement to become Patron of a second created Channel 102. The Property can pay a fee for each Channel, on a Channel by Channel basis, thereby licensing the platform, accessing, and using the platform. The Property can allow its sponsors to access and use the other “side” of each Channel on the platform (in these embodiments, each sponsor is a Recipient of a Channel). For example, the Property can grant access privileges to a Sponsor for a selected Channel 101. Thus, Properties can easily access the platform, from any location and at any time, to manage and organize their full Sponsor roster from a single account on the platform.

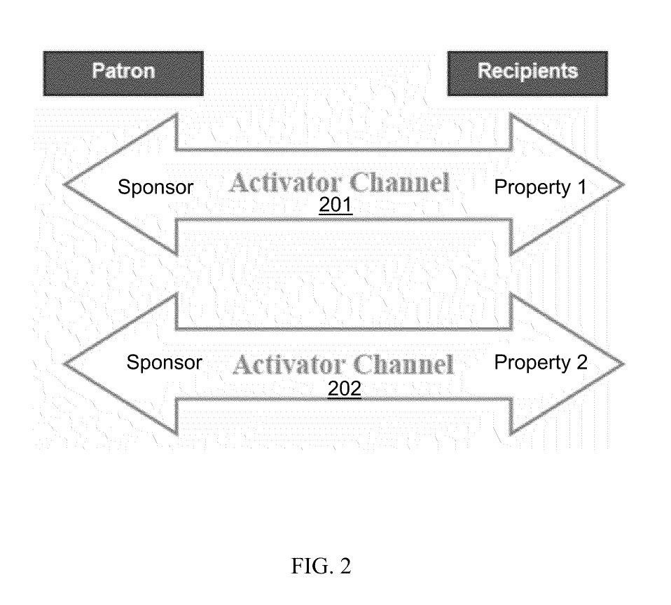

In another example, depicted in FIG. 2, a Sponsor signs Patron agreements with the platform provider, thus becoming the platform provider's client and the Patron of its Channels 201 and 202. The Sponsor would pay a fee for each Channel, on a Channel by Channel basis, thereby licensing the platform, and then accessing and using the platform. The Sponsor can allow its Properties to access and use the other “side” of a Channel on the platform corresponding to the Property. For example, the Sponsor can grant access privileges to a Property for a selected Channel 201 or 202. As Sponsors may have a portfolio of sponsorships spanning many different Properties, perhaps in many different markets, Sponsors can license the platform and access the platform, from any location and at any time, to manage and maximize these relationships from a single account.

If a Property and a Sponsor are both Patrons (i.e., both parties are licensing the platform), and the Property and Sponsor share a single Channel with one another, both the Property and Sponsor can fee to the platform provider for the Shared Channel. In some implementations, the Property and the Sponsor share the fee for the Channel.

In any of the implementations in which there is a Patron (e.g., paying client) on one side of a Shared Channel and a Recipient (e.g., non-paying or subsidized client) on the other side, the Recipient can access the Shared Channel but cannot combine the information in this Shared Channel with the information in any other Channels into a single portfolio view. Only a paying client with a license (e.g., a Patron) can be permitted to combine information from multiple Channels into a portfolio view.

In many implementations, the platform can keep each Channel (i.e., each sponsorship) separate. In this manner, in FIG. 1, a Sponsor 1 can access its Channel 101 with the one Property, but cannot access the Channel 102 between the Property and another Sponsor 2. Likewise, in FIG. 2, a Property 1 can access its Channel with a Sponsor, but cannot access the Channel between that Sponsor and any other Property.

In some implementations, a Property can be a Patron or a Recipient. In some implementations, a Sponsor can be a Patron or a Recipient. In some implementations, once a Patron Agreement is signed with the platform provider, then that entity (whether it be a Property or a Sponsor) will be a Patron on all its Channels. The entity can obtain a portfolio view of all their Channels.

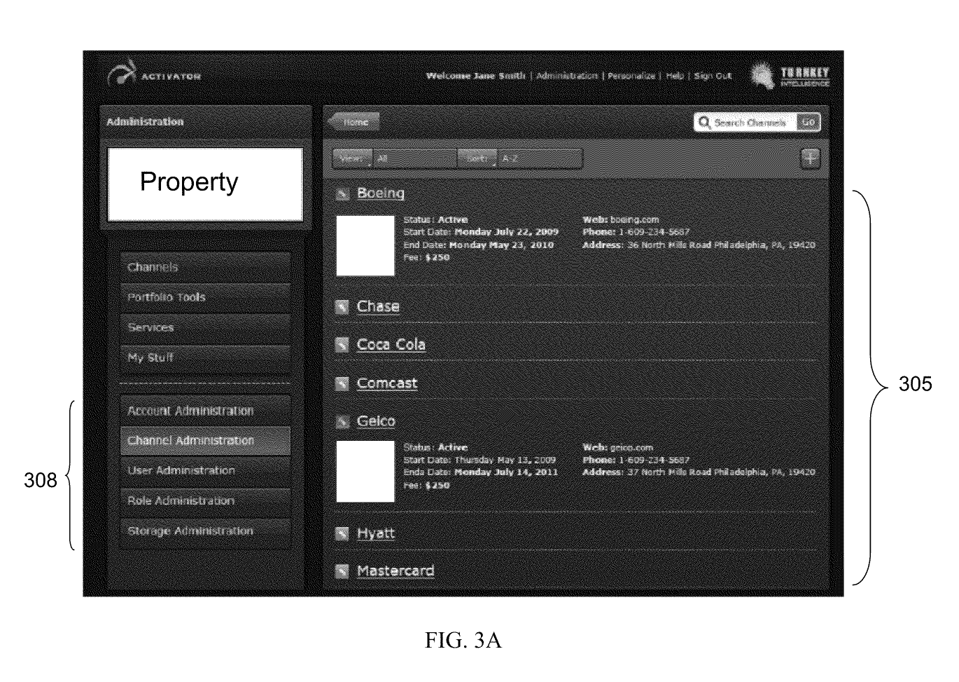

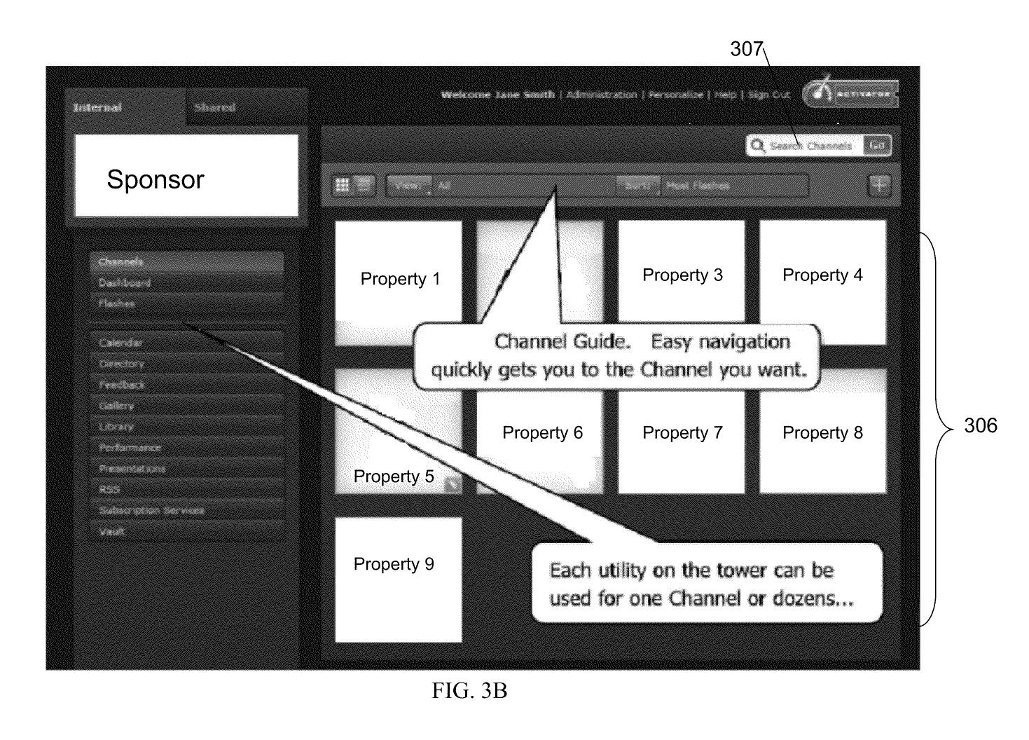

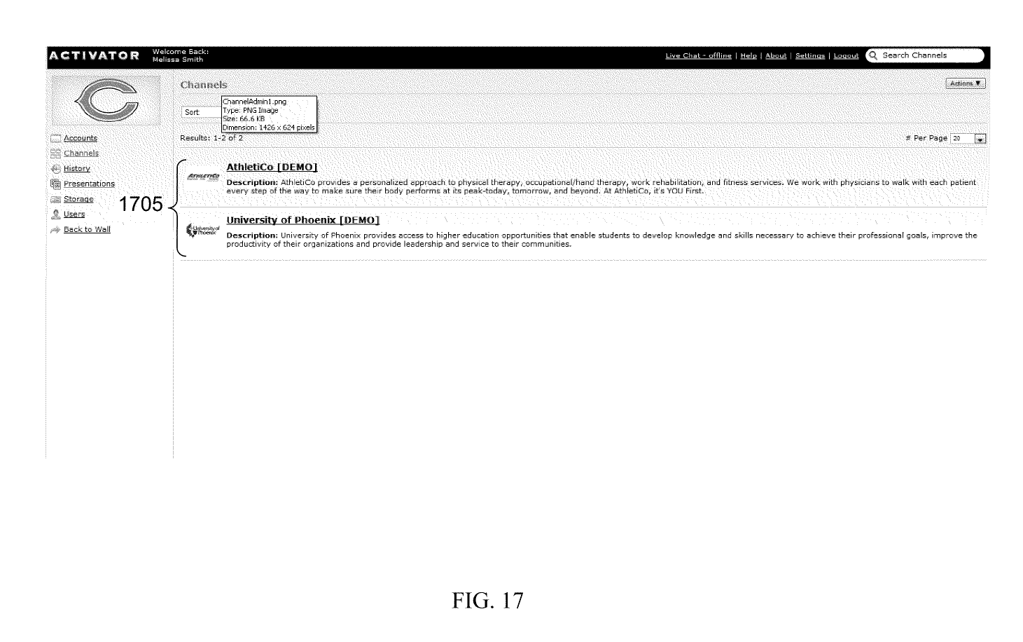

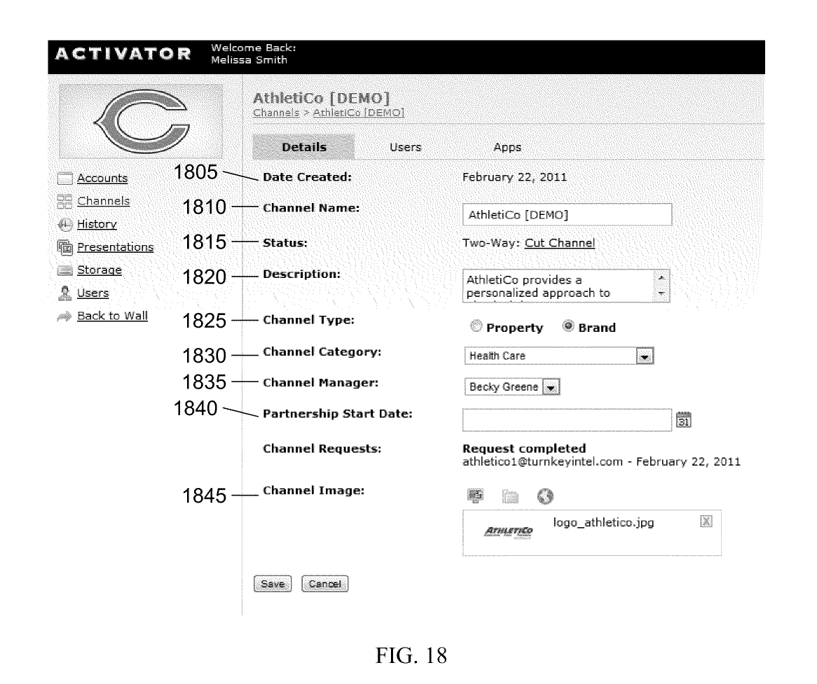

In operation, upon logging into an account associated with a Sponsor or Property, a user can arrive at a homepage depicting Channels, such as those depicted in the exemplary screen shots of FIGS. 3A, 3B, and 18. The homepage can display Channels for sponsorships associated with the user's Sponsor or Property. In some examples, such as FIG. 3A and FIG. 17, the homepage can list the Channels 305, 1705. From the list 305, 1705, a user can select the name of a marketing partner to navigate to a sponsorship overview screen associated with the partner. In another example, such as FIG. 3B, the home page can arrange the Channels in a mosaic layout 306, allowing users to identify Channels corresponding to marketing partners by, e.g., logo, category, name or tag (via keypad search). From the mosaic layout 306, a user can select a Channel to navigate to a sponsorship overview screen. In some implementations, Recipients may view the homepages such as the exemplary screenshot depicted in FIG. 17.

In some implementations, the user can drill into a specific module to examine data or results across multiple sponsor Channels or a single Channel. For example, when a Property user clicks on an “Exposure Valuation” module, the platform can present comparative metrics from the sponsors' marks. In some implementations, this view of the data may not be shared with the other “side” of a Channel if the data relates to multiple Channels.

From the lists 305, 1705 or mosaic layout 306, users can navigate among the Channels through any number of navigation techniques. For example, users can enter text in a type-ahead field 307. In another example, users can select from hyperlinked letters, “A”-“Z.” In response to the selection of a letter, the platform can display Channels corresponding to sponsorship agreements with entities beginning with the selected letter. In some implementations, users can filter Channels according to any of the following exemplary parameters: All, My (all Channels associated with the user's organization or the user, individually), Patron (Channels where the user's organization is the Patron), and Recipient (Channels where the user's organization is the Recipient). In some implementations, users can sort Channels according to any of the following exemplary parameters: All, Updated (Channels with new activity since the user's last login), New (Channels within the first year of a contract), Renewal (Channels within the last year of a contract), and Size of the contract (e.g., large, midsize, small). Patrons can peg a total contract value to a Channel.

In some implementations, a homepage can include multiple controls that provide functionality for one or more Channels. Controls can provide utility functions or data services to the Channels. Exemplary utility functions 308 include account administration, channel administration, user administration, and storage administration. Exemplary utility functions 309 include management of the fulfillment of sponsorship terms, bulletins (also referred to herein a “Flashes” or “Walls”), and reports. Exemplary subscription data services that can be fed into the platform if desired and purchased by a Patron include television and radio ratings, brand exposure tracking and valuation, media clipping provision, web analytics, research, and/or inventory management. The controls can have different scopes of functionality or applicability to differing numbers of Channels depending on whether the user is associated with a Patron or a Recipient. Some controls can provide functionality for individual Channels, while other controls can be directed to overall management of a sponsorship portfolio. Although the present disclosure refers to “controls,” one of ordinary skill in the art would understand that any mechanism that organizes functionality can be substituted for such controls. The functionalities described herein can be organized in any alternative manner as understood by persons of ordinary skill in the art.

The scope of user interactions with functionalities or data services described herein can be modified according to the group of the user associated with a Patron or Recipient. Primary users, such as sponsorship managers or directors and activation staff, can have full access to the platform and the most comprehensive set of user roles and permissions. For example, the platform can grant primary users capabilities and permissions for account setup and management of sub-accounts, management and organization of partners and Channels, full access to data modules including the ability to configure modules, explore data visualizations, publication of results through one or more sponsor Channels, ability to enable or disable data service modules per sponsor Channel, create and distribute reports, interact and communicate to sponsorship partners via the Channel, and edit and view the sponsorship timeline and calendar.

The platform can grant secondary users a more restricted set of roles and permissions. Examples of secondary uses can include personnel (e.g., content providers) that supply the primary users with data, information, or other assets such as images, videos, or results like attendance or circulation) or support staff who assist with the activation or management of one or more sponsorship programs (e.g., coordinators or even interns). These secondary users can be granted variable access to Channels; variable access to data modules; rights to upload and manage data, information, and assets; variable access to view and or edit calendars, schedules and timelines; and the ability to create/edit reports or summaries.

Additionally, the platform can grant read-only views of Channels to users expected only to track progress of the sponsorship portfolio, such as upper level management and executive teams. These users can be granted full or variable views into each Channel; rights to upload notes, information, and other assets; permissions to interact and communicate to the marketing partner via the Channel; and abilities to access and/or create reports or summaries.

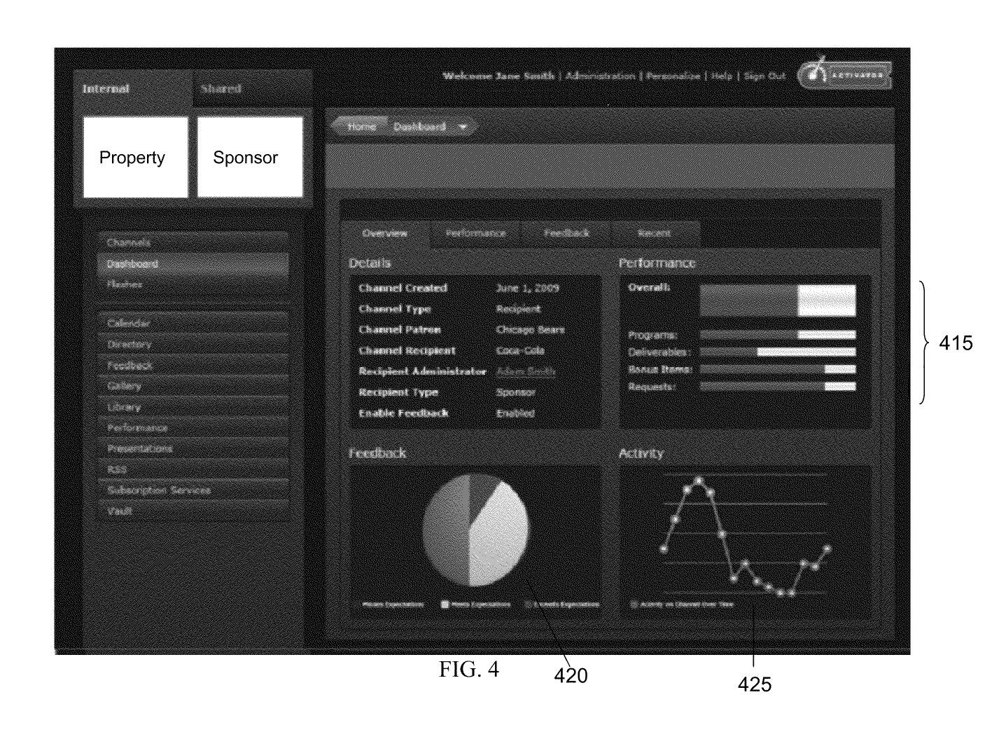

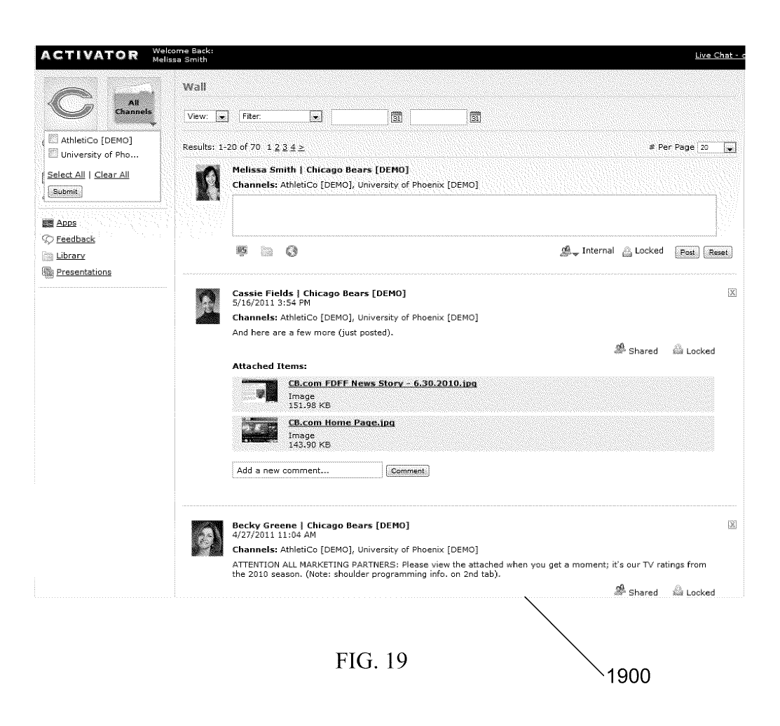

Returning to the operation of the Channel, after a user selects a Channel, the platform redirects the user to a default starting point, such as a Dashboard (e.g., exemplary screenshots of FIGS. 4 and 18) or Bulletins, also referred to herein as “Flashes” or “Walls” (e.g., exemplary screenshot of FIG. 19) for that Channel. The Dashboard overview screen can provide basic information about the Channel, such as the name of the Channel, identities of the Patron and Recipient, and/or the date the Channel was created. The Dashboard overview screen can include a configurable view that highlights important and/or timely metrics, results, and statuses. For example, the screenshot of FIG. 4 can depict bar graphs 415 showing how the Patron rates the Recipient's performance of the sponsorship terms, a pie chart 420 describing types of feedback, and a graph 425 depicting levels of user activity on the Channel.

In some implementations, the Dashboard Overview screen can include information about the Channel. Exemplary information can include the date the channel was created 1805, the name of the Channel 1810, the status 1815 of the Channel, a description 1820 of a party to the Channel, the Channel type 1825, the Channel Category 1830 (e.g., an industry sector of a party to the Channel), the Channel manager 1835 (also referred to herein as the Channel administrator), the start date 1840 of the partnership agreement, and a logo 1845 associated with a party to the Channel.

Throughout a Channel, users can set and/or view goals and objectives. The platform can display and remind all parties of the ultimate mission of the sponsorship relationship in various parts of the Channel. Goal statements can be associated to various measurement modules so that each goal is considered in context during the activation period. As a user views information in the Channel, the user can evaluate the success or failure of a sponsorship by comparing the sponsorship's outcomes to the original set of goals and objectives. For example, an example goal statement can be “Increase awareness among a Property's clients with the Sponsor's new product line.” This goal statement can be displayed proximate to marketing data obtained from data service providers to assess the increase in awareness among the Property's clients of the product line in question.

With respect to the account administration control, the control can deliver different functionality for users associated with Patrons than users associated with Recipients. When the user is associated with a Patron, the account administration control can deliver functionality to each individual Channel as well as to multiple Channels. In some implementations, the account administration control can be available only to users specified as Patron administrators. Information associated with this control can be viewable and changeable by the Patron's users or Patron administrator but can be inaccessible to Recipients.

In some implementations, from the channel administration control, a Patron can select settings for each Channel. The size can be applied to the sponsorship as the platform creates and configures each Channel. A Patron can manage each Channel profile. A Patron can create, activate, edit, or deactivate Channels. Fields for each Channel can include: Setup (e.g., name of Recipient, sponsorship start date (also referred to herein as partnership start date), Channel start date, sponsorship end date, Channel end date, total value of sponsorship, deal size, deal tags, per Channel fee, monthly minimum fee, Recipient's logo, copy of sponsorship agreement); Administrator (e.g., the name of the person at the Recipient who will hold “Administrator” status for the Recipient on that Channel, and the person's title, company, email, office phone and/or cell phone); Data Services (which services should be activated for the Channel); and Confirm (an option that places the Channel on a list of approved Channels). Fields for each Channel can include: Channel status, Channel description, Channel Type, Channel Category, or Channel Manager (who may or may not be the same as a Channel Adminsitrator).

A Patron can maintain the list of approved Recipient Channels for billing purposes. Any Channel appearing in the list for any portion of any month during the term of the Patron's contract with the platform provider can be charged a per Channel fee. For each Channel, the list can include the Recipient name, the Recipient administrator, the sponsorship start date, the Channel start date, the sponsorship end date, and the Channel end date.

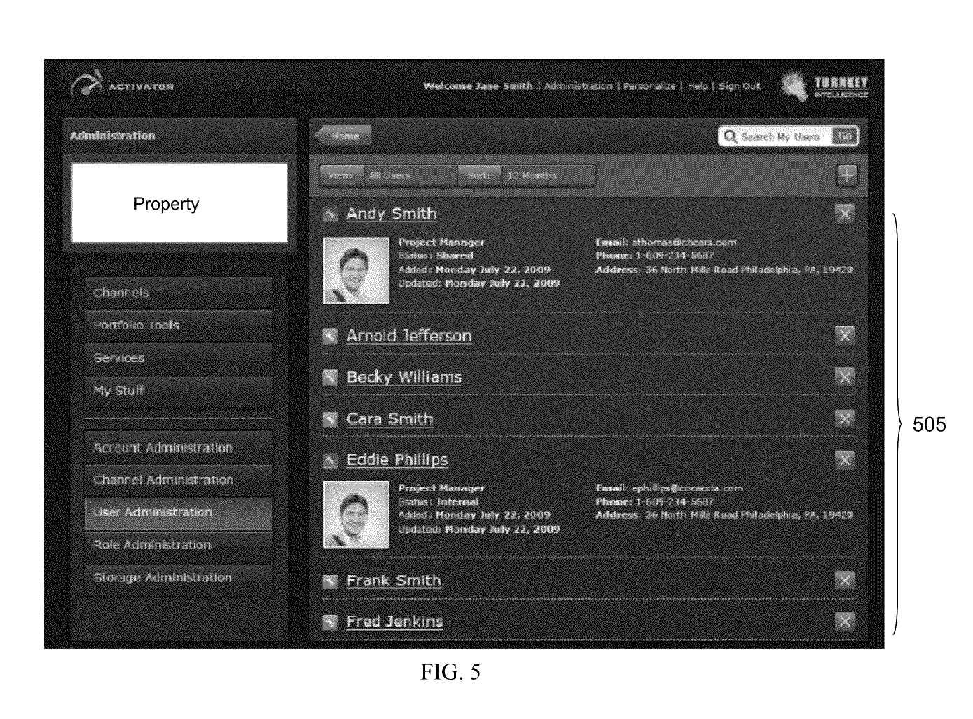

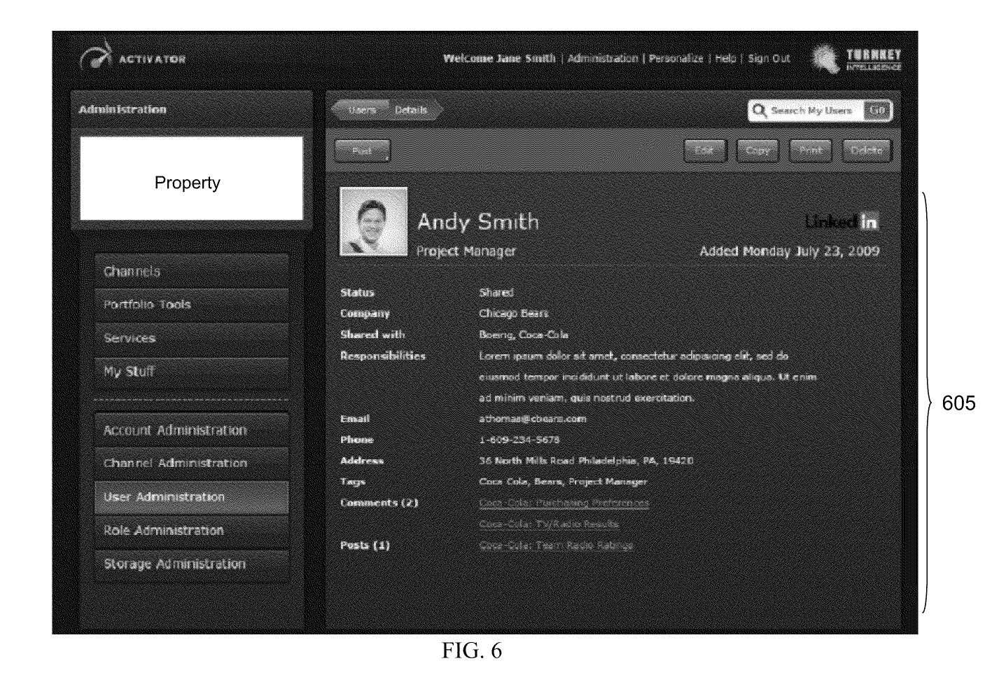

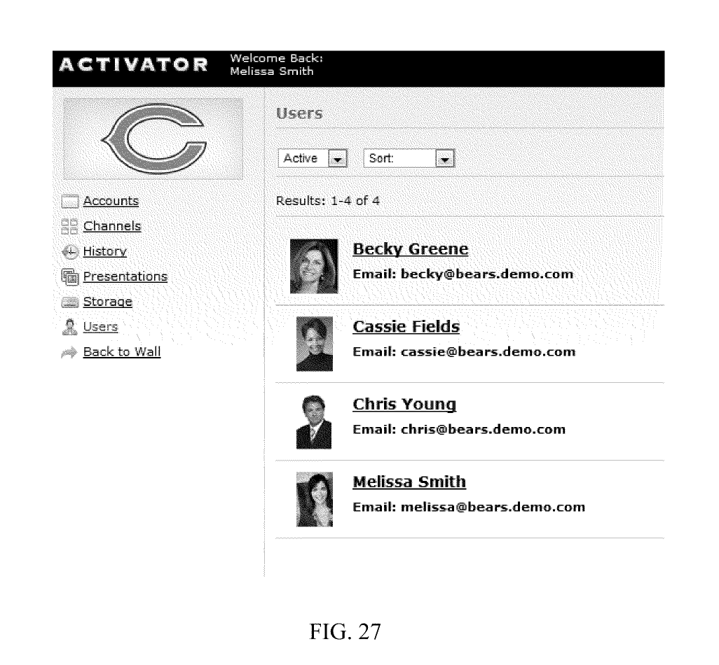

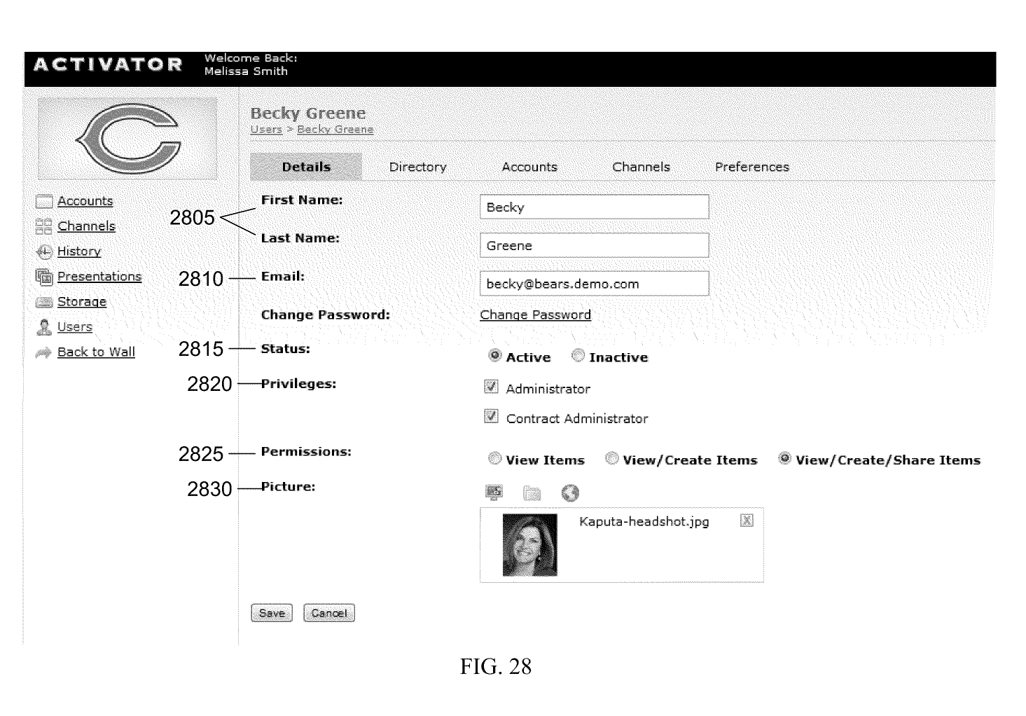

From the user administration control, the Patron can manage a roster 505 of authorized users. A Patron can create and manage the Patron's list of approved users, e.g. employees or agents of the Patron. The list can include information on each user such as the user name, title, headshot, company, role, and/or contact information (e.g., email, office phone, and/or cell phone), as depicted in FIGS. 5 and 27. In some embodiments, selecting a user from the list can permit a user of the service to access additional information about the user, as depicted in FIGS. 6 and 28. From either view, a Patron can manage user profiles for each approved user of the Channel.

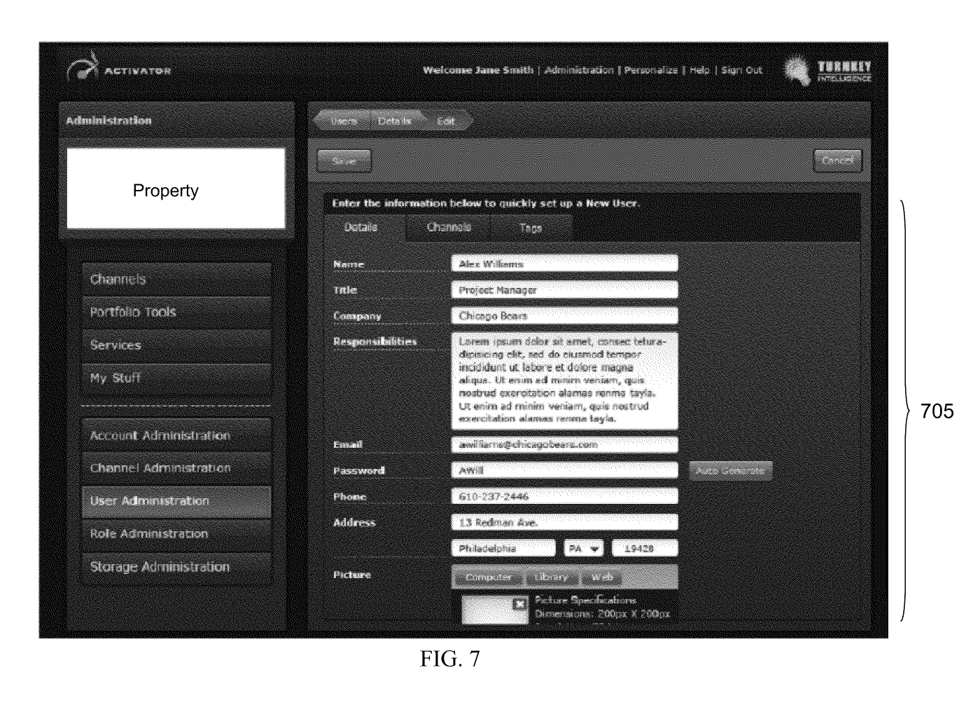

In some implementations, Patrons can add, edit, copy, or delete profile information. Each profile can include modifiable parameters such as: Setup 605 (status, company that employs the user, description of the user's role at the company or responsibilities for the sponsorship, contact information, tags, comments, posts headshot photo images); Directory (a setting indicating whether the user is to be published to the Directory, which parties the user would be visible to, and for which Channels); and Confirm (an option to save the user profile). Each profile can include modifiable parameters such as name 2805, e-mail address 2810, status 2815, privileges 2820, permissions 2825, and image 2830. User profiles associated with Recipients can include comparable information to user profiles associated with Patrons. Patrons can add new users or edit existing users via fields in an interface such as the screenshots depicted in FIGS. 7 and 28.

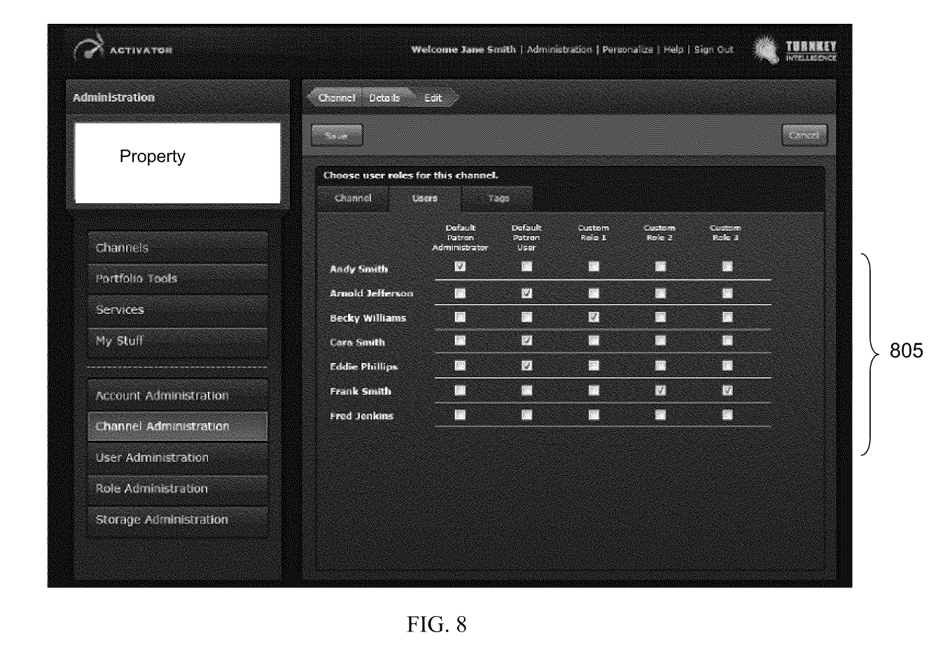

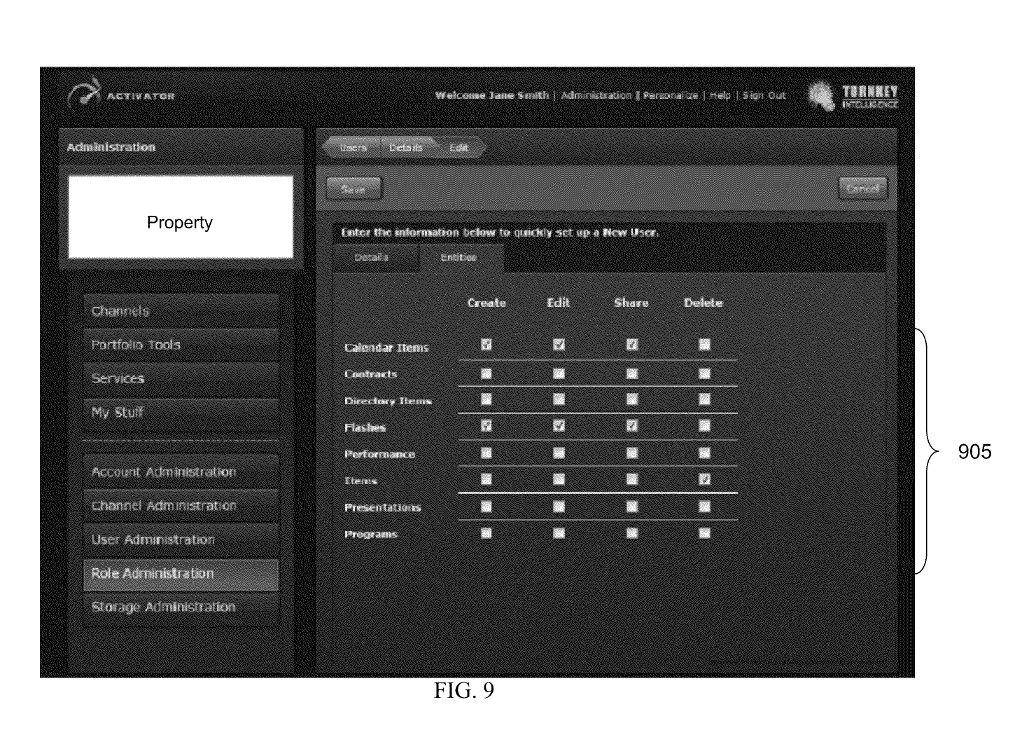

The Patron can designate each user's set of permissions for the Channel by assigning each user a role 805, as exemplified in the dashboard of FIG. 8. In some implementations, any user designated as a patron administrator can activate/deactivate/edit any Patron Channel, activate/deactivate any of Patron's Data Services, approve/disapprove/edit any user profile associated with a Patron or Recipient, publish the Patron's Directory or Calendar to any or all Patron Channels, participate in all Patron Channels, and view all Patron Channels. In some implementations, any user designated as a Patron user can view and participate in the Channel. Patrons can customize various sets of permissions to grant to individual users. For example, Patrons can select which actions users can take if they have been assigned a customized role 905, as depicted in FIG. 9. After such sets have been customized, a Patron can assign each customized set to one or more authorized users of the Channel.

When the user is associated with a Recipient, the administration control can deliver functionality to the single Channel being subsidized by the Patron. In some implementations, even if a Recipient is receiving multiple subsidized Channels, i.e. free Channels, from different Patrons, the Recipient does not receive multi-Channel functionality or portfolio views. Thus, even if a Recipient has 50 Patrons, thereby receiving 50 subsidized Channels, the Recipient must either (a) work within each Channel separately; or (b) sign a Patron agreement and become a Patron (e.g., paying client) in order to be able to receive portfolio views and Dashboards fed by all 50 Channels and be able to manage all 50 Channels collectively. In some implementations, information on a Recipient's administration control can be viewable and changeable by the Recipients' users or administrator, and cannot be accessed by the Patron.

A Recipient can create and maintain a list of approved users, such as employees or agents of the Recipient. The list can include information on each user such as the user name title, headshot, company, role, and/or contact information (e.g., email, office phone, and/or cell phone), as depicted in FIG. 5. In some embodiments, selecting a user from the list can permit a Recipient access additional information about the user, as depicted in FIG. 6.

Each Channel can have both a private “internal” work space for each marketing partner and a “shared” workspace (e.g., tab) for viewing and managing the fulfillment of sponsorship terms contained in the sponsorship agreement between the marketing partners. The shared workspace can be accessed, viewed, and modified by both the Patron and Recipient. Data in shared workspace permits the parties to verify the terms and progress of the sponsorship deliverables. Exemplary tabs include objectives, performance (e.g., contracts, periods in the contracts, programs of the contracts, deliverables for the program(s), occurrences associated with the contracts), calendar, libraries, inventory, feedback, presentations, RSS feeds, opportunities, galleries, and archives. Both the Patron and the Recipient can have their own private library in addition to a shared library. For the other sub-functionalities, both the Patron and Recipient can view and/or collaborate on the same content.

From an objectives control (not shown), either the Patron or the Recipient can add, delete or edit an objective at any time. Each action for an objective can be time stamped. Each objective can have supporting strategies and factors, which the parties on the Channel can edit collaboratively. The Patron and Recipient can each set the status of the objective, from their perspective. The parties can indicate that an objective has been approved or declined, or if the objective remains under review. When both parties have approved an objective, the platform can set the objective status accordingly. Further, either party can post any type of document(s) connected with an objective proximate to the objectives themselves.

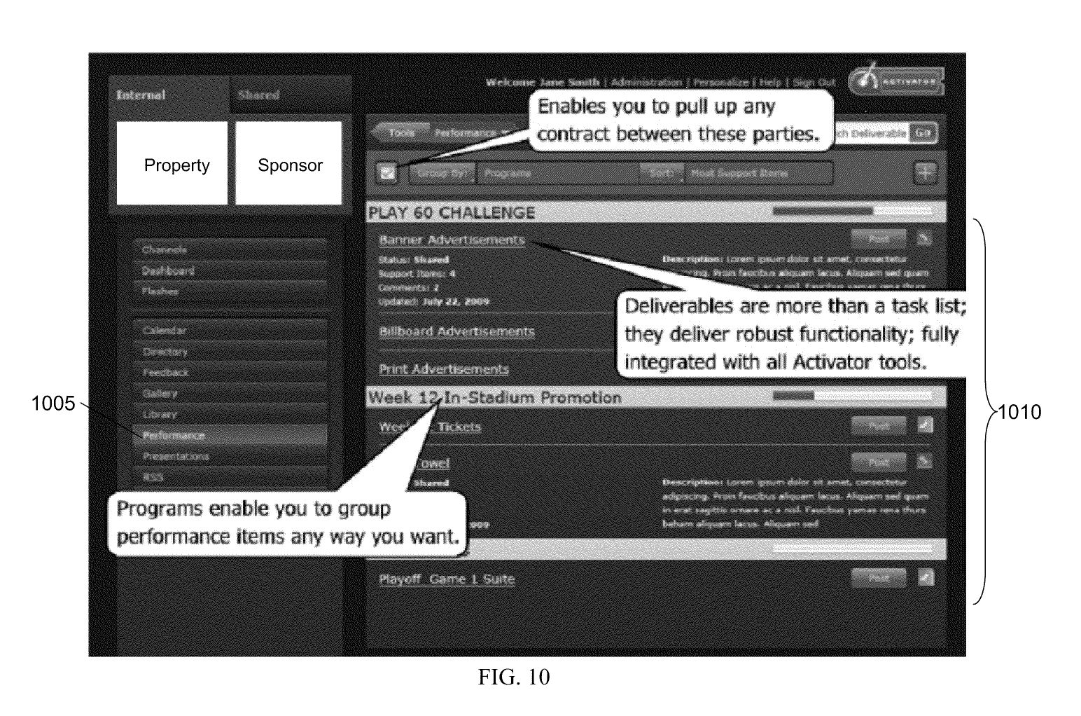

The platform can include a performance control 1005 that tracks deliverables. FIG. 10 depicts an exemplary screenshot of content associated with the performance control. The deliverables 1010 can be grown out of the sponsorship goals and objectives, or the sponsorship agreement. Each deliverable can have a title, description, status, and/or deadline date(s). In some embodiments, a deliverable can be assigned to or associated with one or more contacts in the directory. The Patron or Recipient can add, delete or edit a deliverable at any time. Each action for a deliverable can be time stamped. The Patron and Recipient can each set the status of the deliverable, from their perspective. The parties can indicate that a deliverable is approved, under review, or declined. When both parties have approved a deliverable, the platform sets the deliverable status accordingly. Further, either party can post any type of document(s) connected with an deliverable or set of deliverables. A deliverable can be considered complete when users from both parties have changed its status to “complete”. In some embodiments, deliverables can be evaluated and rated through feedback widgets.

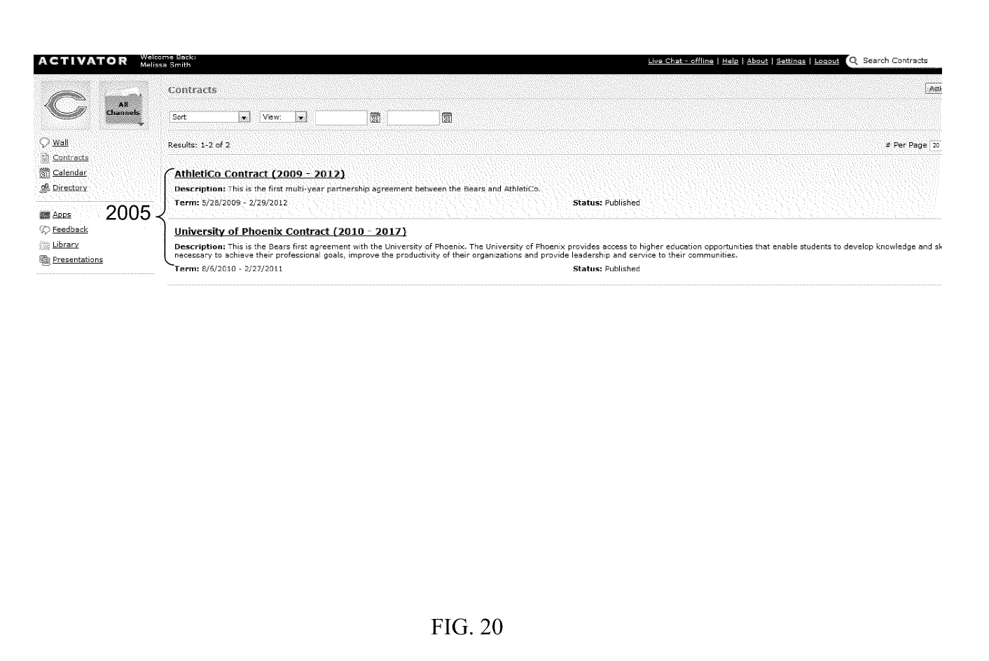

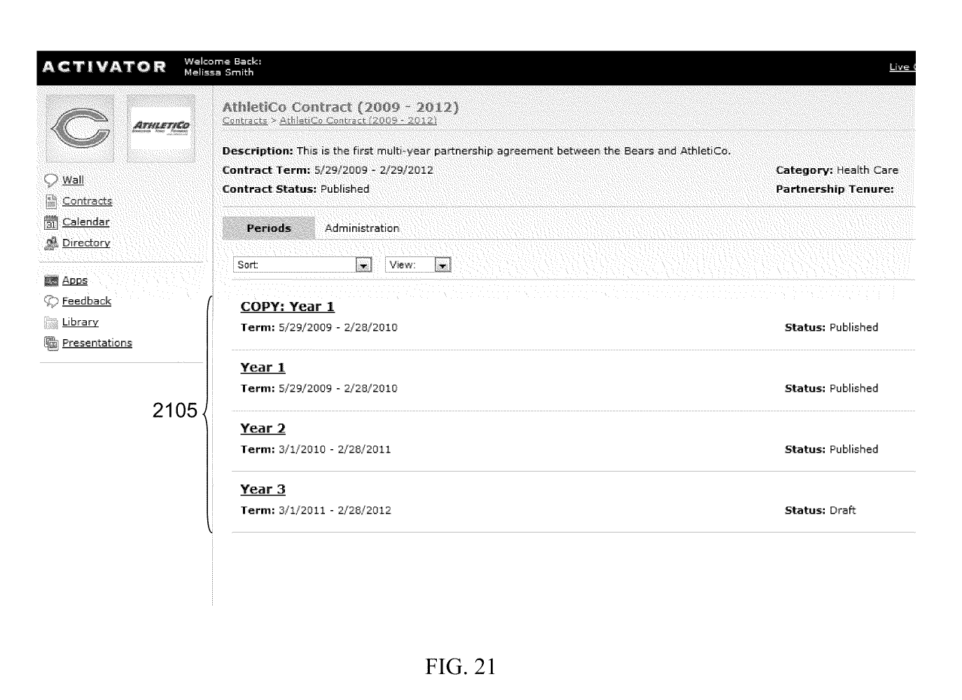

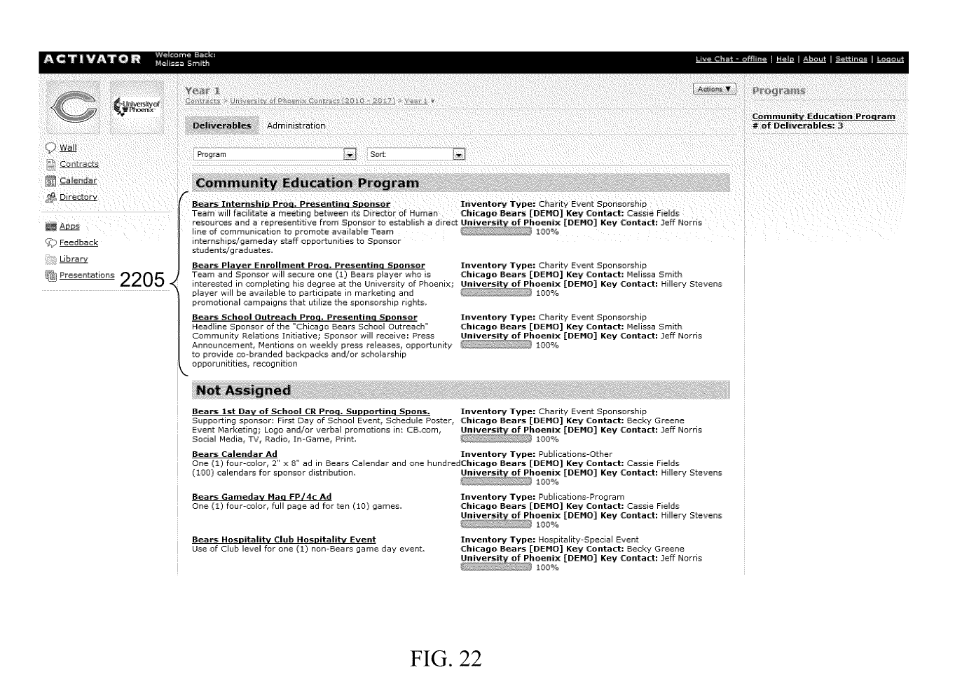

In some implementations, the platform can organize deliverables based on contracts for sponsorship agreements. For example, the platform may list contracts 2005 a party has signed, as depicted in the exemplary screenshot of FIG. 20. By selecting a contract, the platform may display a list 2105 of subcontracts, as depicted in the exemplary screenshot of FIG. 21. For example, a contract can span multiple years, with different terms applying to different periods of time. The platform can organize display of the contract according to obligations in force during different periods of time. By selecting a period of time, the platform may display a list of programs 2205 for which the parties are obligated to enact during the period of time, as depicted in the exemplary screenshot of FIG. 22.

By selecting a program, the platform may display a list of deliverables associated with the program. Each deliverable may be subdivided into occurrences, whose collective achievement attain the deliverable. Each deliverable may have its own bulletin for posting messages regarding progress towards achieving the deliverable, results of efforts, proof of performance, and other information as would be appreciated by one of ordinary skill in the art.

In some implementations, the platform can display a directory of users which does not need to conform to the authorized users on each side of the Channel. In some implementations, the users can be displayed side-by-side, i.e. Patron users on one side and Recipient users on the other side. The directory can include head shots of the users. In some implementations, the directory can list all the approved users and additional, non-user staff from the Patron and the Recipient. The list can include the contact information and role of each person.

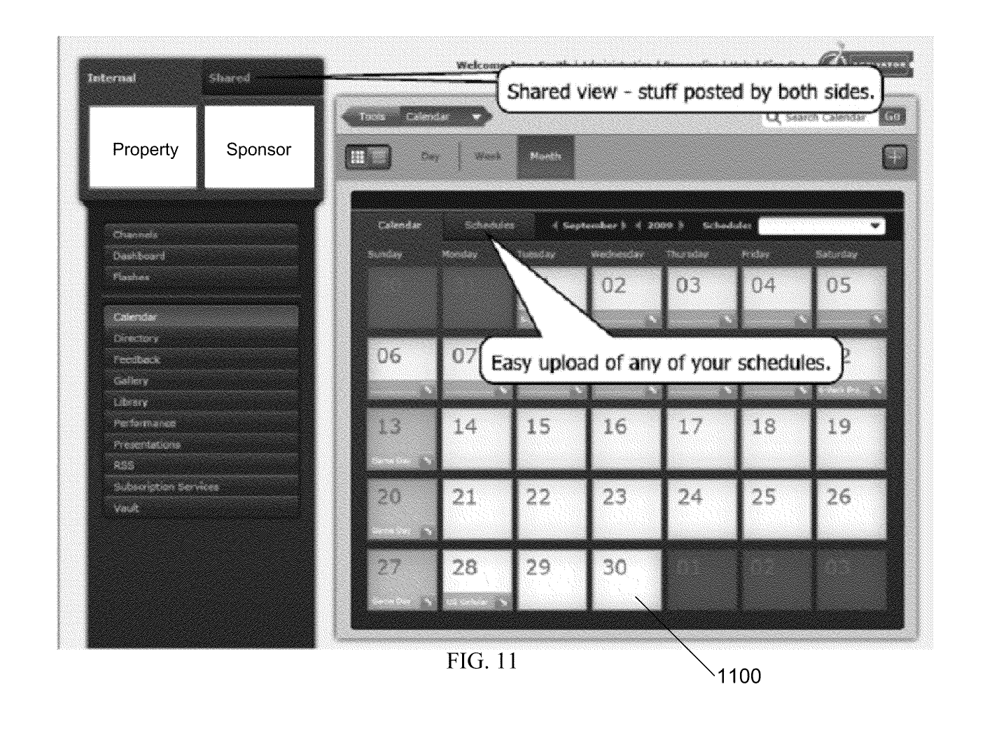

In some implementations, the platform can display a calendar associated with the sponsorship, such as the exemplary calendar 1100 of FIG. 11. A Patron can also publish a calendar to show activities, events, reminders, or other items the Patron wishes to show. The Patron can publish any item or recurrence internally (viewable only to the Patron side), or shared externally (viewable also to the Recipient side), to one Channel, to multiple Channels, or to all Channels. In some implementations, as an administrator sets up a Channel profile, the platform ports date-specific events to the calendar, such as the sponsorship start and end dates. A Recipient can publish a calendar to show activities, events, reminders, or other items the Recipient wishes to show. The Recipient can publish any item or recurrence internally (viewable only to the Recipient side) and/or externally (viewable only to the Patron side) for the particular Channel.

In some implementations, the calendar can be displayed as a single Outlook type calendar with views by Day, Week and Month, or as a list in which items (single or recurring) are displayed. The calendar can be seamlessly integrated with Outlook or any other calendar applications so that users can upload any item or recurrence into their Outlook calendars.

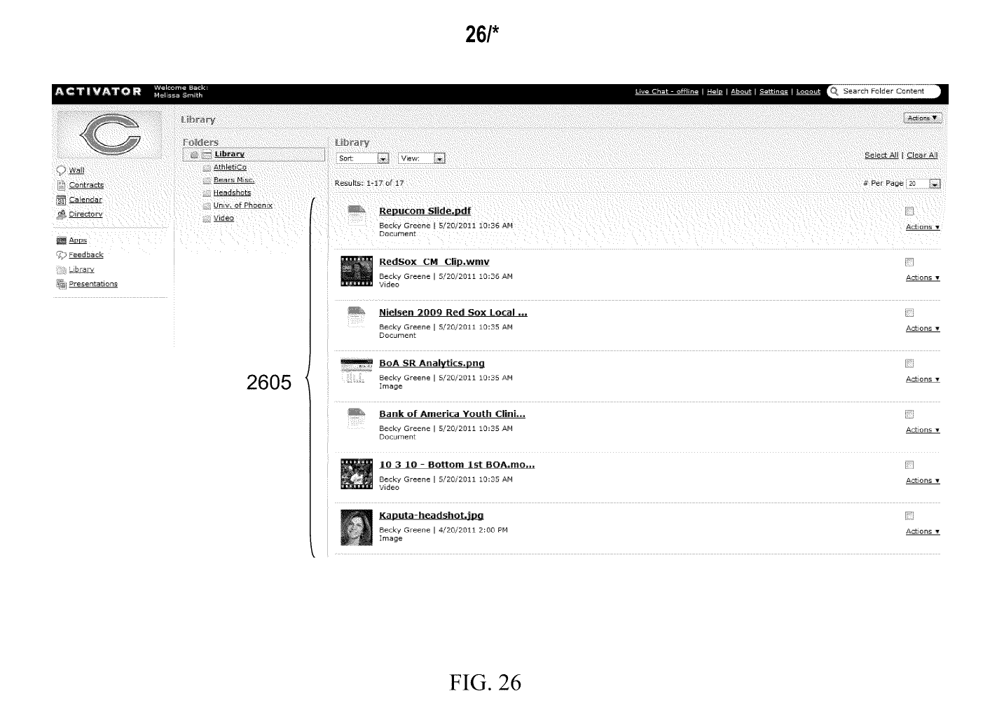

The platform can include private and/or shared asset libraries, such as the library depicted in the exemplary screenshot of FIG. 26. The libraries can be organized by folders and/or subfolders. Each folder can have view and/or edit permissions set based on user. Either party can post any file at any time to their own private library. Such actions can include the name of the user posting the file, the user's organization affiliation, and the time stamp. These assets can have shared or private permission settings. For example, any file with a shared permission set can be automatically entered into a shared asset library.

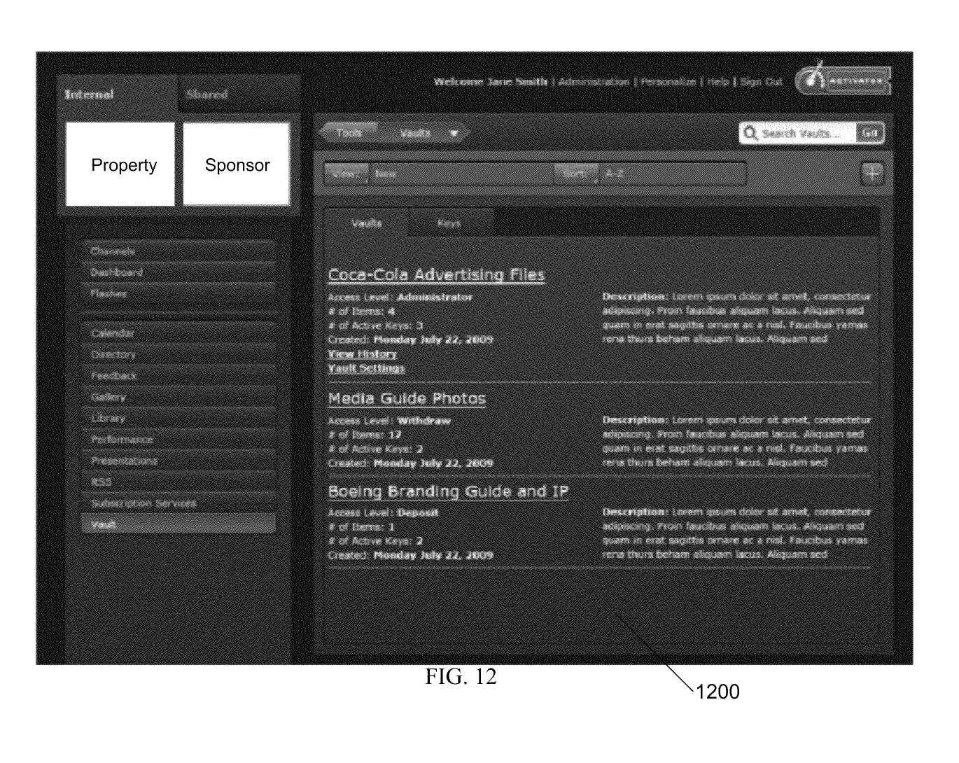

In some implementations, users can “tag” each file with metadata to help the platform generate a thumbnail for the file. Thus, users can see the file at a glance and the platform can use the thumbnail to index the file for future searches. Exemplary metadata for file tags include the file name, file description, item type, keywords, logo, and/or image. Exemplary examples of metadata include the library to associate with the file (e.g., the Patron's library or the Recipient's library), the start and end dates for which the file can be available in the library, indication that the file should be entered into a shared library, and the start and end dates for which the file can be available in the shared library. In some implementations, a file can be moved to an archive (e.g., a vault, such as the vault 1200 depicted in FIG. 12) after the file is no longer available in the libraries. Any of these metadata can be required or optional.

Patrons and Recipients can navigate among the files in any manner. Such users can scroll through the files, apply a search function to the files, filter the files, and/or sort the files. In some embodiments, users can filter the files by file type, e.g. document, image, or video. In various embodiments, users can sort the files in alphabetical order, reverse alphabetical order, or age. Additionally, when a user is accessing files in a shared library, the user can filter by Patron or Recipient.

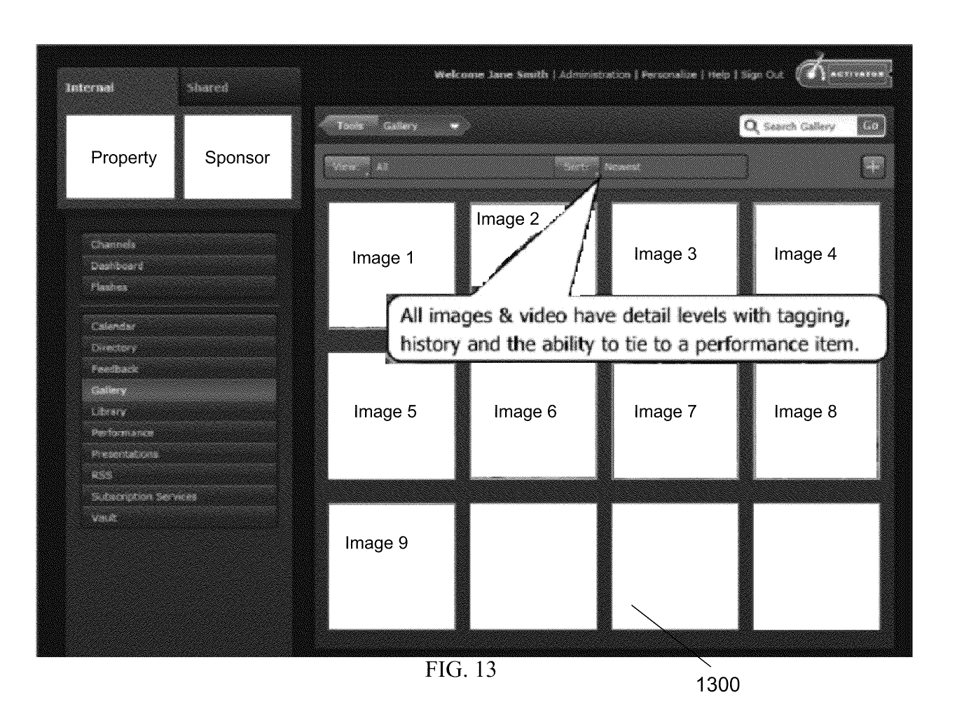

Examples of these files include contract, memos, creative executions, approvals, insertion orders, commercial affidavits, and/or sales results. The parties can upload any type of document, such as word processed documents, spreadsheets, pdfs, or slide presentations. Libraries can also include one or more galleries for photographic images, video, and other multi-media files. In some embodiments, multi-media files can be stored in separate galleries, such as the gallery 1300 depicted in FIG. 13. Further, the assets can be available for use as a resource throughout the platform, though the assets may be used primarily on custom slides.

The platform can track inventory and opportunities. The platform can offer a private view into available inventory. The Property can browse its inventory and publish information about the inventory to a specific Channel or the Property's entire sponsorship roster. In some implementations, the Property can directly offer an opportunity through a specific Channel or the Property's entire sponsorship roster. These opportunities can be offered via messages (e.g., email or system), posted on custom slides, or posted in association with events and other timeline items.

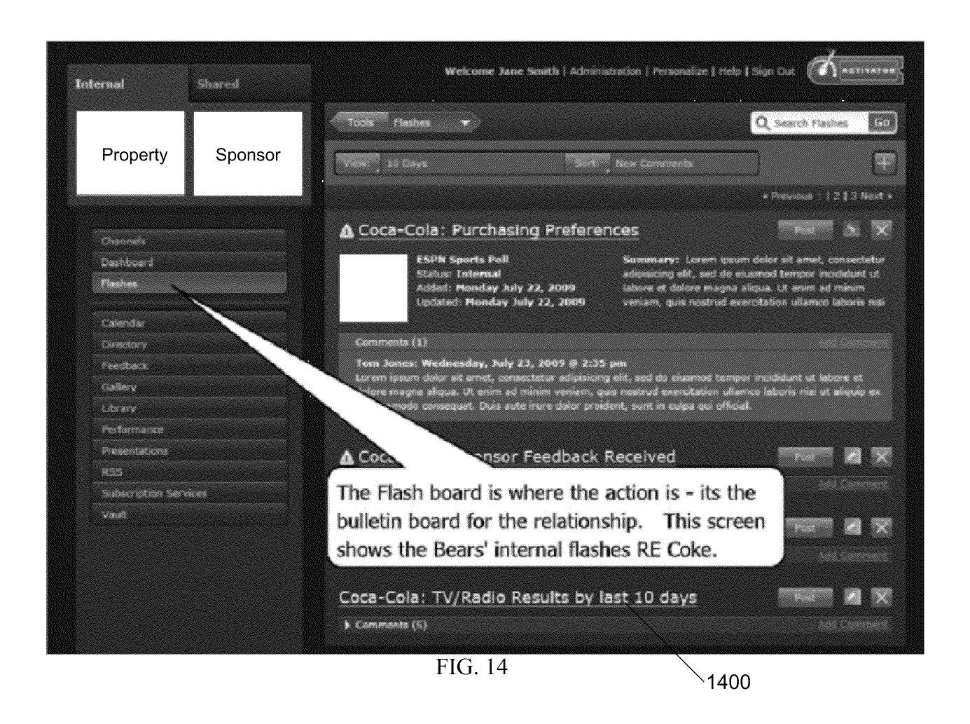

The Patron and Recipient of a Channel can access, view, and participate in a communication forum such as a bulletin (also referred to herein as Flashes or Wall Posts), as depicted in the exemplary screenshots 1400 and 1900 of FIGS. 14 and 19. In some implementations, a bulletin can relate to a sponsorship agreement in its entirety. In some implementations, a bulletin can relate to a subcontract of the sponsorship agreement. In some implementations, a bulletin can relate to a deliverable for a subcontract. Users can view and post comments. In some implementations, the bulletin can be integrated with and/or complementary to email. Thus, each user can personalize how (and how often) they wish to have the platform notify their email address of new postings on the bulletin. Comments posted to the forum can be organized and searchable. In some implementations, users can post comments and reply to posted comments, attach a “tag” or other keyword to any post and/or reply, attach a document to any post and/or reply. Users can select settings for integrating the forum with email. For example, users can elect to receive email notifications of new posts, have their emails copied on all new posts from their organization or the opposite party, and/or upload an email string into the forum for storage. In operation, the bulletins tab can include current, actionable, and/or highlighted aspects of the sponsorship. In this manner, functionality for the bulletin can be incorporated throughout the platform. For example, from other positions in the Channel, a user can place an item from the position into the bulletins tab, thereby highlighting the item for other users of the Channel. Such items can include the name of the user posting the file, the user's organization affiliation, and the time stamp.

In some implementations, Patrons and Recipients can copy items to the bulletins tab to indicate a new staff person has been added to the directory, a new item has been added/modified in the calendar, a new objective has been added or fully agreed to, a new “opportunity” is available, a new string of comments are in the forum, media has been uploaded (e.g., photographic images such as a sponsor's encapsulated displays or videos such as recent press conferences), a recent research report has become available, fresh radio ratings have arrived, a new image valuation report has been delivered, a new recap has become available, and/or a document has been attached to any post and/or reply. The item posted to the bulletins can include a thumbnail or link to facilitate access to the posted information.

Patrons and Recipients can “tag” each item in the bulletins tab with metadata to help the platform generate a thumbnail for the item. Thus, users can see the file at a glance, users can highlight the item for other users, and the platform can use the thumbnail to index the item for future searches.

Exemplary metadata for item tags can include the item name, item description, item type, keywords, logo, and/or image. Exemplary metadata can include start and end dates for which the item will appear and remain on the bulletins tab, and recurrences (e.g., the ability to schedule future postings of a recurring data service). Users can navigate among the items in any manner. Users can scroll through the items, apply a search function to the item, filter the item, and/or sort the items. In some implementations, users can filter the items by item type, e.g. document, image, opportunity, or video. In some implementations, users can sort the items in alphabetical order, reverse alphabetical order, or age.

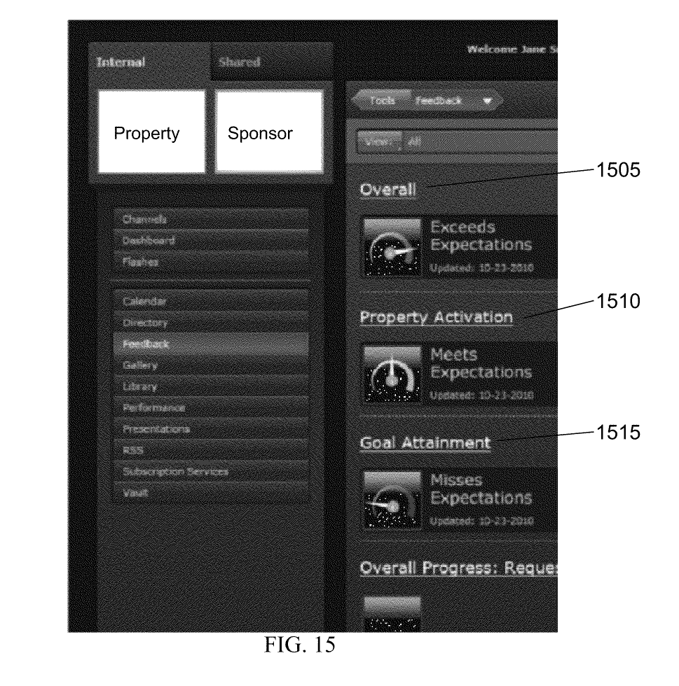

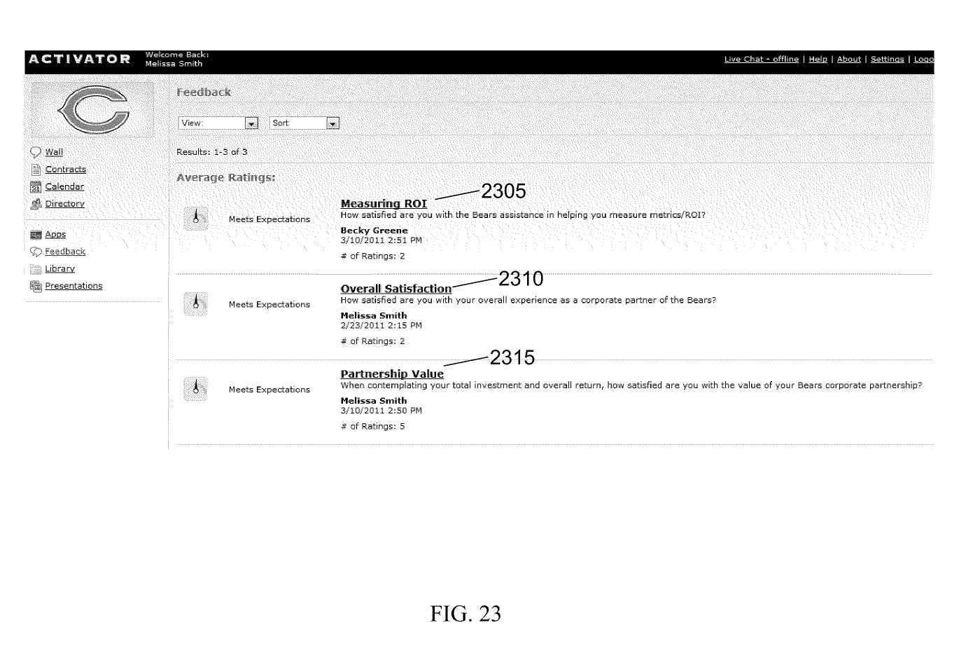

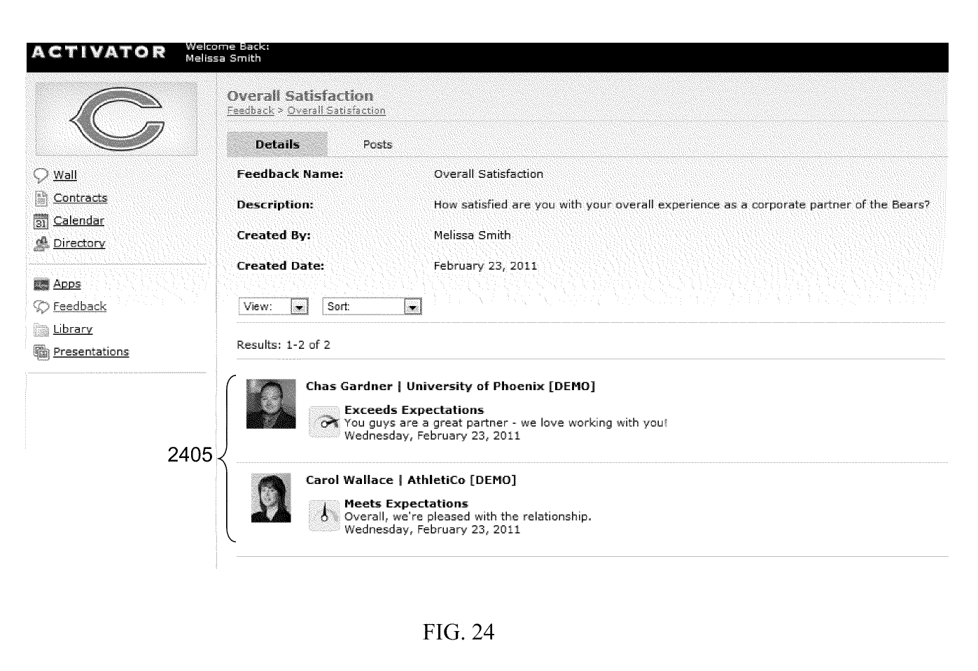

The platform can permit either marketing partner to rate the performance of the other marketing partner. For example, as in the screenshot of FIG. 15, the feedback screenshot permits the sponsor to indicate whether the Property is exceeding, meeting or missing the sponsor's expectations. The sponsor can rate the Property according to subcategories of activities 1505, 1510, 1515 related to the sponsorship agreement or any other metric that the marketing partners wish to mutually create for feedback. In another example, as in the screenshot of FIG. 23, the sponsor can rate the Property according to subcategories of activities 2305, 2310, 2315 related to the sponsorship agreement. In another example, as in the screenshot of FIG. 24, users can post comments 2405 regarding the performance of the marketing partner.

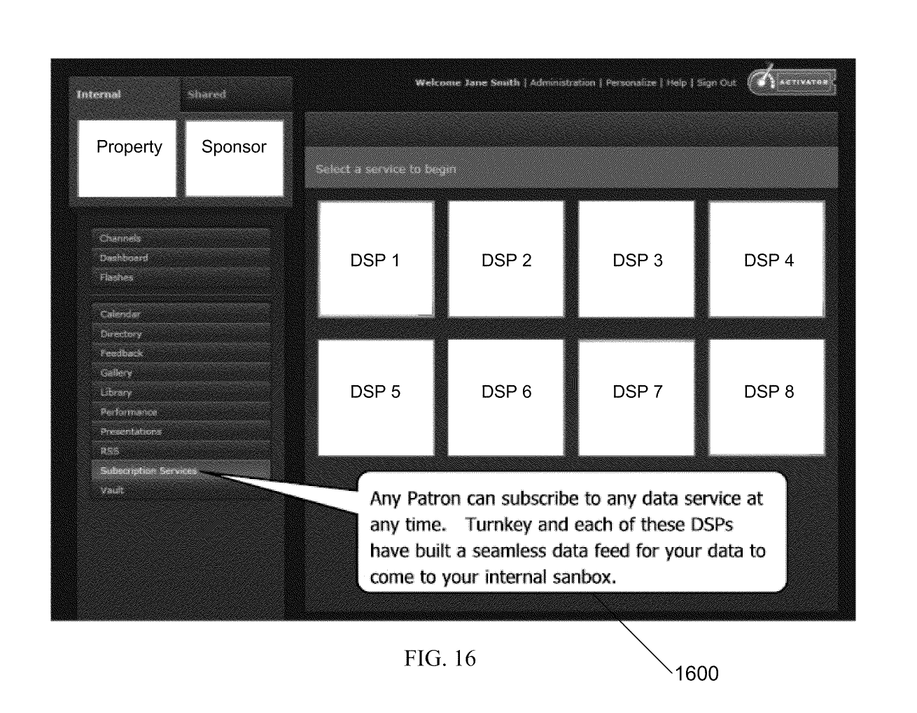

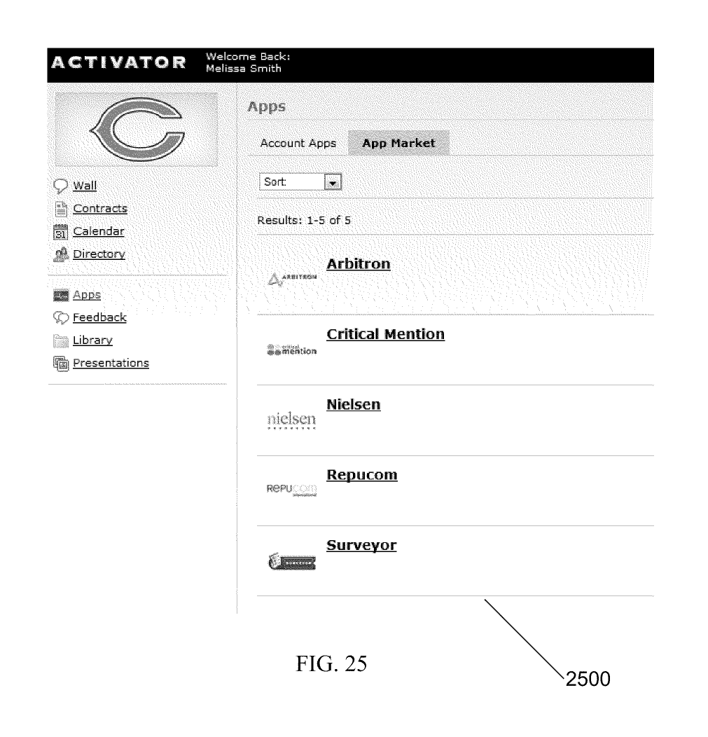

In addition to the utility functions described herein, the platform can provides seamless, fully integrated data services to the Channels (also referred to herein as “subscription services”). The data services can include modules or mini applications that provide information, metrics or results directly pertaining to the measurement of a specific sponsorship component. These modules can present information compiled, distilled, and/or arranged from other systems and platforms. In some implementations, the modules can be configurable and customizable. For example, a user can configure a module to control what is displayed (e.g., timeframe, comparative averages, expectation thresholds and benchmarks, and the like) and how it is displayed (e.g., visibility settings). Additionally, modules may allow for annotation, notes, and feedback from both parties. Such modules available to the Channel can be displayed as in the exemplary screenshots 1600 and 2500 of FIGS. 16 and 25.

A Patron (but not a Recipient) can purchase and then activate one or more subscription data services. In some implementations, only the Patron administrator can activate data services. In some implementations, only the data services supported by the platform can be activated. If a Recipient wants a data service turned on for a Channel, the Recipient must request that the Patron turn it on.

In some implementations, a Patron can submit to the platform provider copies of data server provider contracts authorizing the Patron and/or Recipient's use of the data service through the platform. If the Patron is so authorized, all data coming from the data service provide can be fed to the Patron's tab for the service provider. If the Recipient is authorized, all data coming from the data service provider can be fed to the Recipient's tab for the service provider. If both parties are authorized, all data coming from the data service provider can be fed to both parties' tabs for the data service provider.

In this manner, the Data Service tab can serve in the role of an in-box/storage box designed to be ready to “catch” data coming from the data service provider. In some implementations, the data can come in the form of a templated, pre-arranged or pre-scheduled data feed that occurs automatically or periodically. In some implementations, the data can come in the form of a one-off report or one-off feed that is created by or requested by the Patron. In some implementations, data service tabs can serve as outbound portals to the data service provider's software environment outside of the platform.

In some implementations, patrons can have their own separate, secure tabs for each data service providers to receive and review their private data. Data on these tabs can be inaccessible to other parties on the Channel. In some implementations, this data can become accessible to other parties when the data is posted to the bulletins tab. For example, a data service file or feed can be posted to the recap tab as a potential item in a report.

Modules can provide primary and syndicated research results. For example, a Turnkey Surveyor module can provides real-time or consolidated results from custom research studies. In some implementations, time series data or benchmarking questions automatically update with new results as the new results become available. The platform can allow users to put the results in context and to overlay expectations or goal metrics. Another example of this type of module is the ESPN Sports Poll module that provides syndicated research results that track the sport consumers since 1994. In some implementations, the ESPN Sports Poll module can provide a focus on only data directly relevant to sport sponsorship.

Some modules can provide media ratings. For example, an Arbitron module can provide local, network and nation radio broadcast audience measurement. In some implementations, Arbitron can also offer qualitative consumer and media usage information.

Some modules can provide on-line and mobile analytics. For example, an Omniture SiteCatalyst module can identify the most profitable paths through a given Web site, determine where visitors are navigating away from their site, and identify critical success metrics for online marketing campaigns. Presenting such data in the platform can allow users to view statistics expressly relevant to isolated sites, pages, or marketing campaigns that normally are lost among a massive collection of web data. In some implementations, the Omniture module can offer mobile application metrics instead of or in addition to on-line metrics.

Some modules can provide image or exposure valuation. For example, a Repucom module can provide an accurate and evidence-based brand analysis through image detection technology and brand/logo recognition software. In this manner, the Repucom module can consistently analyze exposure across all different forms of media. The Repucom module can present detailed and ongoing exposure and valuation metrics for sponsors. In another example, a Joyce Julius module can measure and analyze all forms of media, on-site elements and promotions surrounding sponsorships.

Some modules can provide media clipping. For example, the CriticalTV search module can deploy technology that continuously digitizes transcripts and live broadcast footage, in real-time, and indexes and stores each in the CriticalTV media database. Users can perform keyword searches against the database (e.g., search for a company name, product, person, and/or topic) and have their results of their keywords displayed within the platform. Users can then watch the video, read the transcript, forward the clip on to colleagues, order the clip to an archive, or a host of other tasks designed for users to effectively communicate and share their broadcast mentions. Thus, a CriticalTV module can be an access point to statistics and individual video clips related to the sport property and/or the sponsor brand.

Some modules can provide custom information. Some information and statistics cannot be accessed in a standard format from an external application or data source. Thus, modules with basic abilities for uploading and sharing information manually can be beneficial to users. A custom information module can allow a platform user to create custom slides of information for metrics such as print media circulation/distribution, event attendance figures, merchandise sales, and hospitality experiences. The custom information module can assist the user by offering standard slide layouts, basic plotting tools and image views and media players.

In some implementations, the platform can create summaries of the sponsorship agreement. Summaries can include information from any component of the Channel. For example, summaries can list the deliverables that have and have not been achieved for each program and/or year of the partnership agreement. Summaries can include ratings and comments submitted to the feedback mechanism. The platform can select comments from bulletins for inclusion in the summary. Summaries can indicate which users from the parties have been active participants on the Channel. Summaries can depict key events obtained from the Channel's calendar.

The platform can transform a summary into a report. The platform can deliver the report to the parties to the sponsorship agreement. For example, the platform can deliver the report to the e-mail addresses of the Patron and Recipient administrators. In some implementations, the platform can post the report on the Channel, with read accessible available only to the administrators. In some implementations, the platform can interface with a third-party server executing presentation programs to periodically deliver summaries and/or reports to parties to the sponsorship agreement.

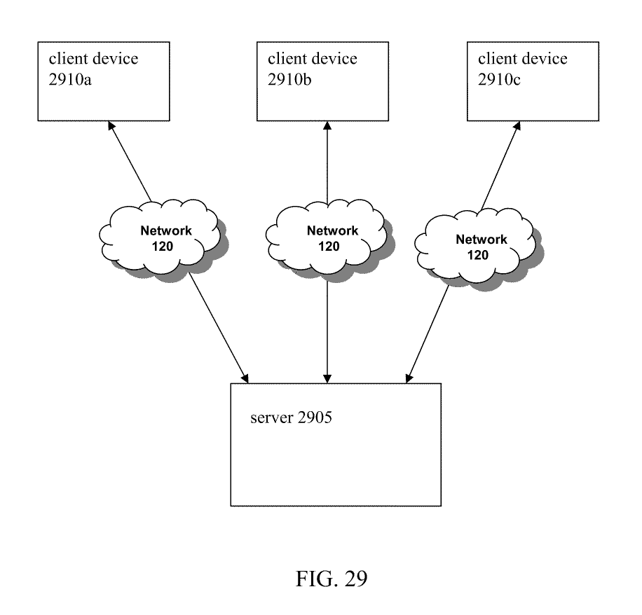

Referring now to FIG. 29, a system 2900 for enhancing communication between partners in sponsorships is shown and described. The system 2900 can include one or more servers 2905 that host a communication platform. Via client devices 2910, partners in the sponsorships and/or administrators of the communication platform can connect over networks 2915 to the server(s) 2905.

In general overview, using a client device 2910, an administrator of the communication platform can send an instruction to create a Channel to the server(s) 2905. In some implementations, the instruction can identify parties that can access the Channel. In some implementations, the instructions can identify access privileges to the Channel that a party can have. Access privileges can differ between the parties. The server(s) 2905 can associate the channel with accounts belonging to the parties. In some implementations, the server(s) 2905 can create an account for a party that can access the channel and associate the channel with the account.

The parties can, via client devices 2910, access the channel on the communication platform. The parties can transmit data for the server(s) 2905 to add to the channel. In some implementations, the parties can retrieve data on the channel. For example, a party can, via client device 2910, send the server(s) 2905 an instruction to deliver data from the channel. The server(s) 2905 can transmit the requested data to the client device 2910. In some implementations, the server(s) 2905 can transmit data corresponding to any of the exemplary screenshots described herein to client devices 2910 for display. In some implementations, the server(s) 2905 can transmit web pages with the data for display on the client devices 2910.

The systems, software, and methods described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

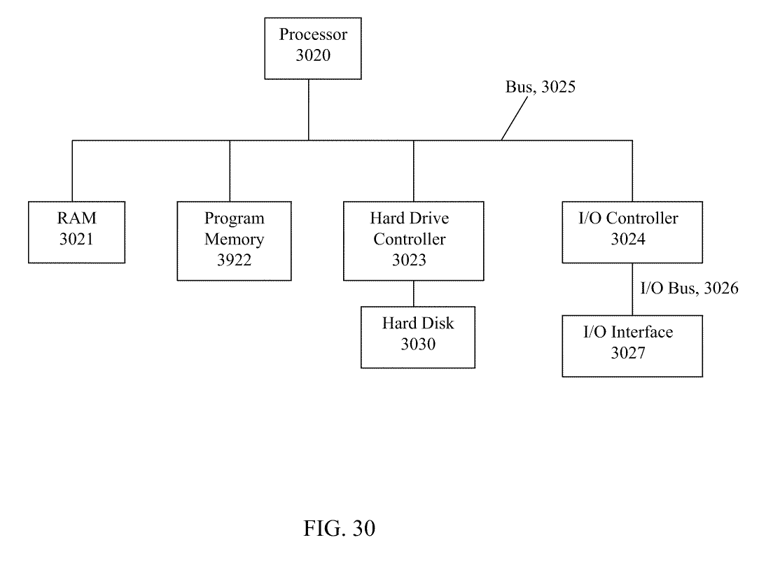

An example of one such type of computer is shown in FIG. 30, which shows a block diagram of a programmable processing system (system) 3011 suitable for implementing or performing the apparatus or methods described herein. The system 3011 includes a processor 3020, a random access memory (RAM) 3021, a program memory 3022 (for example, a writeable read-only memory (ROM) such as a flash ROM), a hard drive controller 3023, and an input/output (I/O) controller 3024 coupled by a processor (CPU) bus 3025. The system 3011 can be preprogrammed, in ROM, for example, or it can be programmed (and reprogrammed) by loading a program from another source (for example, from a floppy disk, a CD-ROM, or another computer).

The hard drive controller 3023 is coupled to a hard disk 3030 suitable for storing executable computer programs, including programs embodying the present methods, and data including storage. The I/O controller 3024 is coupled by an I/O bus 3026 to an I/O interface 3027. The I/O interface 3027 receives and transmits data in analog or digital form over communication links such as a serial link, local area network, wireless link, and parallel link.

In view of the structure, functions and apparatus of the systems and methods described here, the present solution provides a dynamic, efficient and intelligent system for enhancing communication between partners in a sponsorship. Having described certain implementations of methods and systems for providing such a platform, it will now become apparent to one of skill in the art that other implementations incorporating the concepts of the disclosure may be used. Therefore, the disclosure should not be limited to certain implementations.

What is claimed:

1. A method comprising:
receiving, by a processor executing on a server, a request to create a channel associated with a first sponsorship;
creating, by the processor, the channel with a shared workspace accessible to a first party to the sponsorship and a second party to the sponsorship, wherein the first party and the second party track terms of the sponsorship via the shared workspace; and
granting, by the processor, a first set of access privileges for the channel to the first party.

2. The method of claim 1, further comprising:
granting, by the processor, a second set of access privileges for the channel to the second party in response to identification of the second party by the first party.

3. The method of claim 1, wherein creating the channel further comprises:
creating the channel with the shared workspace to track at least one of contracts, periods, programs, deliverables, and occurrences associated with the sponsorship.

4. The method of claim 3, further comprising:
receiving, by the processor, a message regarding a status of a deliverable; and
modifying, by the processor, the shared workspace according to the status of the deliverable.

5. The method of claim 1, further comprising:
displaying, by the processor, metrics of the sponsorship in the shared workspace to the first party.

6. The method of claim 1, further comprising:
displaying, by the processor, the channel associated with the first sponsorship and a channel associated with a second sponsorship to a member of the first party.

7. The method of claim 1, further comprising:
granting, by the processor, a first subset of the first set of access privileges to a first member of the first party; and
granting, by the processor, a second subset of the first set of access privileges to a second member of the first party.

8. The method of claim 1, wherein creating the channel further comprises:
creating, by the processor, a first private workspace accessible to the first party; and
creating, by the processor, a second private workspace accessible to the second party.

9. The method of claim 1, further comprising:
generating, by the processor, a report on the sponsorship according to data in the shared workplace.

10. A system comprising:
a processor; and
a memory, the memory storing instructions that, when executed by the processor, cause the processor to:
receive a request to create a channel associated with a first sponsorship;
create the channel with a shared workspace accessible to a first party to the sponsorship and a second party to the sponsorship, wherein the first party and the second party track terms of the sponsorship via the shared workspace; and
grant a first set of access privileges for the channel to the first party.
